(19) United States
(12) Patent Application Publication
(10) Pub. No.: US 2007/0154689 A1
(43) Pub. Date: Jul. 5, 2007

(54) Composite products contaning a transparent or translucent capstock

(76) Inventors: Thomas B. Hughes, Rancho Santa Margarita, CA (US); Roderick E. Hughes, Newport Beach, CA (US)

Correspondence Address: STOUT, UXA, BUYAN & MULLINS LLP, 4 VENTURE, SUITE 300, IRVINE, CA, 92618, US

(21) Appl. No.: 11/650,406

(22) Filed: Jan. 4, 2007

Related U.S. Application Data
(60) Provisional application No. 60/756,460, filed on Jan. 4, 2006.

(51) Int. Cl. G03G 7/00

(52) U.S. Cl. 428/195.1

(57) ABSTRACT

Compositions comprising improved extruded thermoplastic composite materials having the appearance of wood, and methods for their manufacture. The novel compositions comprise a clear or translucent surface layer which causes a perception of depth and realism in simulated wood composite products having uses including fencing, decking, flooring, siding and the like.

This patent application claims priority under 35 U.S.C. §119(e) to provisional patent application Ser. No. 60/756,460, filed Jan. 4, 2006, which application is hereby incorporated by reference herein in its entirety.

### FIELD AND SUMMARY OF THE INVENTION

The present invention relates to compositions comprising improved extruded polymeric materials, particularly composite polymeric materials which have one or more enhanced properties.

Extrusion of polymeric thermoplastic materials, including composite thermoplastic materials containing added materials such as wood fiber, wood flakes, wood flour, wood shavings, sawdust, coconut, hemp, and other organic materials, inorganic materials such as glass fiber, talc, and mica, metal materials, such as steel, iron, or bronze shavings or wire is known in the art. Such composite materials may comprise a single composite material, or preferably may comprise a “layered” composition comprising two, three, or more layers of coextruded materials having different properties. For example, a multi-layered composition may comprise an inner foamed or unfoamed layer that may further be covered with a relatively thin capping layer. Commonly used thermoplastics include, without limitation, acrylonitrile/styrene/acrylic (“ASA”) polymeric materials, acrylic polymeric materials, polystyrene polymeric materials, polyvinyl chloride (“PVC”)-based polymeric materials, and acrylonitrile/butadiene/styrene (“ABS”) polymeric materials.

Products made from extruded thermoplastic profiles are commonly used in a large number of applications, including applications traditionally calling for the use of wood. The polymeric materials named above, and other polymers known to those of skill in the art, have excellent properties including resistance to decay and degradation brought about by extremes of heat and cold, decay and the like. These factors can be combined to refer to a single property; for example, weatherability, of such materials. As used herein, the term “weatherability” refers generally to the ability or property of a material to effectively withstand the conditions of an out-of-doors environment, including heat, cold, precipitation and the like, over a long period of time, for example, at least five years and preferably at least seven years, with substantially no degradation or decomposition.

Residential, commercial and industrial architecture commonly involve the use of decorative structural and nonstructural components in the assembly of useful articles. These components are often made from wood. Not only is wood relatively lightweight, but the aligned fibers fibers in wood endow longitudinally aligned structural and non-structural members with a great deal of strength. Additionally, wood can be milled into shaped structural components such as sized lumber, trim, post and beam, and can be used to form structural components that can be assembled with glass to form door and window units. Furthermore, lumber, trim, post, beam and assembled profiles or articles (or units) comprising wood have obvious utility and are well adapted for many uses in many residential or commercial installations.

However, the use of wood can be problematic in certain of these applications. As mentioned above, wood can deteriorate due to the effects of, for example, fungus, insect attack, and extremes of temperature. Also, wood members are becoming increasingly expensive, as the availability of domestic sources of wood suitable for construction purposes declines. Furthermore, wood requires substantial upkeep comprising painting or staining.

Foamed and non-foamed thermoplastics, (including, without exception, PVC, ASA and ABS) containing wood have been used as wood replacements. With specific regard to foamed (hollow) thermoplastics, for example, U.S. Pat. No. 6,054,207 discloses the use of a foamed thermoplastic such as polyvinyl chloride and wood fiber for the purpose of manufacturing high strength composite materials. See also U.S. Pat. Nos. 5,486,553, 5,539,027, 5,406,768, 5,497,594, 5,441,801 and 5,518,677; these and all other patents, published patent applications and other publications cited in this patent application are hereby incorporated herein in their entirety. Composites such as the ones described in these publications are useful in the manufacture of a structural member, such as a hollow profile, that can be used in window and door manufacture. Foamed thermoplastics are more durable and avoid many of the above-referenced problems associated with wood. Traditionally, foamed thermoplastic/wood compositions are formed using various blowing agents.

Whether comprised of hollow or non-hollow thermoplastics, or of single or multilayer composite materials, thermoplatic composites are useful in, for example, fence and deck systems and fence and decking components, such as rails, fence posts, fence slats, flooring, decking planks, siding, roofing materials and the like, as well as methods for producing the same. Composites are easy to manufacture in a variety of configurations using relatively inexpensive materials. In addition, composites are sturdy, lightweight and have excellent weatherability properties. Furthermore, they have many of the desirable properties of natural wood products, such as building products. For example, the composites of the present invention, in any form, but especially in the form of fence, deck, spa boards, window siding, window lineals, roofing and flooring systems or components, are millable and can be made to have something of a wood-like look and texture. However, unlike solid wood fences and decks, the composites of the present invention are generally highly resistant to effects of weathering, particularly when covered by a weatherable coating or capstock.

Capstocks are known in the art. Thus, for example, in the finished product capstocks may comprise a first layer comprising a first polymer. The first polymer may contain a polymer selected from the group consisting of ASA, acrylic, polyolefins (such as polystyrene, polyethylene and polypropylene), thermoplastic polyurethane, unplasticized polyvinyl chloride (RPVC), acrylonitrile/butadiene/styrene (ABS), polyethylene terephthalate (PET), polycarbonate, styrene/acrylonitrile (SAN), styrene-butadiene-copolymers (K-resins®) and alloys and mixtures comprising said polymer. These materials are capable of being formulated as transparent or translucent capstock.

Capstocks may comprise an impact modifier. Impact modifiers may comprise an acrylic and/or a latex-based microparticulate, such as, without limitation, microspheres comprising a core comprising 50% butadiene and 50% butylacrylic rubber and a shell comprising 10-20% methylmethacrylate. All percentages reported in this application are by weight, unless expressly indicated otherwise.

In a preferred embodiment of the present invention, depth and a more realistic wood-like appearance can be bestowed upon an extruded composite material made to resemble wood by using a capstock that is transparent or translucent in conjunction with the use of decorative features viewable through or within the capstock. In a particularly preferred embodiment, the transparent or translucent capstock is less than about 0.5 inches thick; or less than about 0.2 inches thick, or less than about 0.1 inches thick or less than about 0.05 inches thick or less than about 0.03 inches thick, or less than about 0.01 inches thick. In another embodiment the range is between about 0.005 and 0.1 inches. The capstock will generally be added to the extruder in a dry powdered and/or pelleted form. A “dry mix” as used in this patent application shall mean a dry mixture of pelleted and/or powdered capstock or core polymeric material, containing any desired additives such as, without limitation, filler, decorative features, color accent pellets and or color concentrate material. While pellets of diverse sizes may be used, generally the pellets are substantially homogeneous in average size and are, for example, less than about 0.5 inches in diameter, or less than about 0.3 inches in diameter, or less than about 0.2 inches in diameter. The particles, which may be of any shape, such as substantially spherical, cylindrical, or rectangular, and may have have a longer axis and a shorter axis having a ratio of about 2:1. A currently preferred size is about 0.1 inches by about 0.2 inches. In less preferred embodiments the material may be pulverized or powdered rather than pelleted; in such case the granule size is generally less than that of the pellet.

Either or both the capstock or the underlying base composite may contain added decorative features to, for example, aid in the ability of the final extruded product to have a more realistic simulated woodgrain-like appearance. Such decorative features may comprise, for example, color accent pellets, which have a higher melting temperature than the capstock polymer or the base composite, as the case may be. During extrusion these pellets soften and are dispersed in the surrounding molten polymer. Due to their higher melting temperature, and through modulation of the temperature at which the extrusion process is conducted, upon partially melting their complete mixture with the molten capstock or base polymer during the extrusion process is restricted. The movement of the extrudate through the extruder causes these semi-melted color accent pellets to cause a streaking effect in the composite layer, resembling woodgrain.

The color accent pellets are well-known and commercially available. These pellets are alloyed pellets comprising a resin such as an acrylic polymer, a polycarbonate, etc. The melting temperature of the pellets is relatively high (greater than about 150° C.). The pigment, which may be of any suitable color, is typically the color of woodgrain, such as black, brown, tan, or red, and is mixed into the alloy. The pellets may also contain a stabilizer material and any other common additive. The resulting pigmented resin alloy can then be chopped into pellets of, for example, about 1/32 inch to about ⅛ inch in size prior to being loaded into the extruder. However, in other embodiments the color accent pellets may comprise a pulverized powder of an approximately uniform size less than about ⅛ inch or less than about 1/32 inch in size; these smaller color accent pellets will provide thin streaks or blots when extruded. Thus, the term “color accent pellets” means pelleted or powdered pigmented polymeric material, preferably acrylic, polyolefin (such as polypropylene or polypropylene), butacrylate, or polycarbonate in nature, having a higher melting temperature than the capstock polymer or the base composite, as the case may be. Generally, the higher the average molecular weight of the polymer, the higher the melting temperature of the color accent pellets.

The addition of color accent pellets to an opaque polyvinyl chloride (PVC)/TiO₂ capstock to make a simulated wood-like vinyl siding product has been described in Saloom, U.S. Pat. No. 5,387,381, the disclosure of which is hereby incorporated by reference herein. The color accent particles in the product described by Saloom are visible only on the surface of the capstock layer of a multilayer siding extrudate, and are said to hide the effect of weathering of the siding and surface defects produced in the siding during manufacture.

By contrast, the present invention provides a composite product, useful in building applications including fencing, siding, decking, flooring and the like, that has a superior wood-like appearance due to the transparent or translucent capstock and the sensation of depth (similar to that depth present in natural wood) provided thereby. The streaked color accent pellets are visible through the capstock within either the capstock itself or the underlying base layer.

The capstock and/or underlying base polymer may also optionally contain a coloring agent. This coloring agent may be transparent, translucent or opaque. The coloring agent may be initially present in a color concentrate added to the capstock or base polymer at a point prior to extrusion through an extrusion die. In the case of the capstock, if the color concentrate is opaque, the concentrate is added at a low enough concentration that it will result in the extrusion of a transparent or translucent capstock through which any decorative features in the capstock or underlying base polymer are at least partly visible.

Hills et al., U.S. Pat. No. 6,752,941 (hereby incorporated by reference herein) disclose additives for special effect appearances in plastic parts, particularly to aid in creating effects similar to that of stone, wood and other natural formulations. These additives comprise color accent particles comprising styrene polymers (e.g., acrylic, ASA, AES or other weatherable polymers containing special effects ingredients such as pearlescent pigments, mixed-metal oxides or organic pigments. These additives are introduced into a capstock base material comprising less than about 75% by weight wood flour and a polymer that may be selected from the group consisting of polyvinyl chloride, polyolefins (such as polypropylene, polyethylene, polystyrene etc.) and mixtures thereof.

Unlike the present invention, Hills does not disclose or suggest the advantages present in the current invention. This invention uses a transparent or translucent capstock in an extrusion process in conjunction with color accent particles, including the styrene special effects additives to which the Hills patent is drawn, to produce a more realistic woodlike composite product resembling cabinet- or furniture-quality wood. For example, the present Applicant has found that addition of more than about 1% wood flour to the capstock produces an opaque or nearly opaque capstock in which the advantages of the present invention are either diminished or absent. Accordingly, in a preferred embodiment the capstock of the present invention does not contain more than about 1% of wood flour.

### BRIEF DESCRIPTION OF THE DRAWINGS

FIG. 1 shows an extruded spa board having a clear acrylic capstock layer and color accent pellets in the core and capstock.

FIG. 2 shows an extruded spa board having a transparent acrylic capstock layer containing 5% brown transparent color concentrate and color accent pellets in the core and capstock.

### DETAILED DESCRIPTION

The present invention is drawn to wood-resembling thermoplastic compositions and methods for their production. Methods of producing an extruded product, such as, without limitation, a composite product comprising a transparent or translucent first layer and a second layer comprising a base polymer are provided. Such products are useful for a variety of purposes including building products such as siding, decking, fencing, flooring and paneling.

Thus, in one embodiment the invention comprises a thermoplastic composition comprising:

a) a first layer comprising a first polymeric material which contains a first polymer; and

b) a second layer, in contact with the first layer and comprising a second polymeric material, wherein said first polymeric material is sufficiently transparent or translucent to permit visualization of one or more decorative features present in said first and/or second polymeric layer.

The first polymeric material comprises a transparent or translucent capstock material which may be selected from the group consisting of acrylic/styrene/acrylonitrile (ASA), acrylic, polyolefins (such as polystyrene, polypropylene and polyethylene), thermoplastic polyurethane, unplasticized polyvinyl chloride (RPVC), acrylonitrile/butadiene/styrene (ABS), polyethylene terephthalate (PET), polycarbonate, styrene/acrylonitrile (SAN), styrene-butadiene-copolymers (K-resins®) and alloys and mixtures thereof.

The first polymeric material may also comprise a color concentrate. This color concentrate may be opaque, transparent or translucent, provided that if it is opaque it is present in said capstock at a sufficiently low concentration that said capstock remains transparent or translucent in the finished product. Color concentrates for use in extruded products are commerically available.

The first layer is co-extruded with the second layer and any additional layers enclosed by or underlying the first and second layers. The second layer may be comprised of any suitable thermoplastic including, without limitation, acrylonitrile/styrene/acrylic polymeric materials, acrylonitrile/butadiene/styrene polymeric materials, PVC polymeric materials, acrylic polymeric materials, acrylonitrile/ethylene/propylene/styrene polymeric materials, polycarbonate polymeric materials, polyolefins (which may comprise polypropylene polymeric materials, polystyrene polymeric materials, and/or polyethylene polymeric materials). polyacetyl materials, fluorocarbon polymeric materials, nylons, phenoxy polymeric materials, polyethers, polycarbonates, polyphenylene oxides, polysulfones, polyimides, thermoplastic urethane, elastomers, combinations thereof or mixtures or alloys thereof.

In one embodiment, the first layer contains either very small amounts of TiO₂. In another embodiment the first layer contains no TiO₂. In this context “very small amounts of TiO₂” are those amounts not causing the capstock to become opaque or lose its transparency or translucence. Preferably the4se amounts are between 0% and about 1% by weight, such as less than 1%, or less than 0.8%, or less than 0.6% or less than 0.4% or less than 0.2%. It will be understood that this range specifically discloses and includes any and all ranges falling between 0% and 1% TiO₂.

It will also be understood that the decorative effect provided by the present invention will often be lessened the less transparent the capstock is, and will be nullified with an opaque capstock. In a preferred embodiment the second and/or any additional layers also comprise a filler material. Commonly used fillers comprise wood (for example, without limitation, wood fiber, wood flour or sawdust), other organic fiber (such as, without limitation, coconut fiber, husks, nutshells, hemp, straw and the like), glass fiber (including random fibers, chopped fiber, glass mat or any other glass fiber-containing composition), mica, talc, other inorganic fibers, metal shavings and the like. In a preferred embodiment, the second layer comprises up to about 65% filler, or up to about 50% filler, or up to about 40% filler or up to about 30% filler or up to about 20% filler or up to about 10% filler, or up to about 5% filler or up to about 1% filler. In other embodiments the second layer contains from about 1% to about 65% filler by weight. It will be understood that this range specifically discloses and includes any and all ranges falling between 1% and 65% filler by weight. In a preferred embodiment the second layer contains from about 20% to about 40% filler by weight or about 25% to about 40% filler by weight. Preferably, the filler comprises wood and may comprise combinations of wood and other fillers; more preferably wood flour and combinations of other fillers.

The decorative features may be comprised in the filler. That is, the filler may contain and includes such decorative feature(s). Additionally or alternatively, the decorative features may comprise discrete colored thermoplastic elements visible through the transparent or translucent first layer resulting from the melting of a plurality of color accent pellets within the surrounding polymer. By “pellet” is meant that the color accent pellets are of a suitable size to provide a simulated wood grain feature in the extruded finished product. In one preferred embodiment, the discrete colored thermoplastic elements are contained within the first layer. In another preferred embodiment the discrete colored thermoplastic elements are contained within the second layer. In yet another embodiment the discrete colored thermoplastic elements comprise “streaks” resembling wood grain that are a different color from the color of either or both the first or second layer.

The color accent pellets may, without limitation, be comprised of a polyolefin-based plastic (such as polystyrene, polypropylene and/or polyethylene), an acrylic, polycarbonate, ASA, AES, PVC or an alloy of any of these with another ingredient with. The pellets are formulated to have a melting temperature at least about 50° to about 100° C. higher than the melting temperature of the surrounding polymer. By “melting temperature” is meant the Vicat softening temperature (VST), which gives a measure of the temperature at which a plastic starts to soften rapidly. To obtain the VST a round, flat-ended needle of 1 mm² cross section is applied to the surface of a plastic under a predefined load (usually either 10 Newtons or 50 Newtons) while the temperature is raised at a uniform rate. The VST is the temperature at which the penetration reaches 1 mm.

Even more preferably, the melting temperature of the color accent pellets is about 20° C. to 40° C. higher that the melting temperature of the surrounding polymer. Preferably, the color accent pellets have a melting temperature of between about 100° C. and about 200° C., or about 98° C. and about 160° C., or between about 100° C. and about 150° C. It will be understood that this range specifically discloses and includes any and all temperatures and ranges thereof falling between 98° C. and 200° C.

In certain embodiments the extrudate is embossed with a simulated wood grain texture after passing through the extrusion die. Preferably, the extrudate is subjected to a cooling step before the embossing step. The embossing may comprise a series of “semi-regular” grooves or furrows resembling the texture of wood grain and fiber.

In some embodiments the second layer may comprise a foamed thermoplastic composition. This can be accomplished by any suitable means. In some well-known cases a blowing agent may be used during the extrusion process to provide a foamed composite layer. In other cases the thermoplastic material fed into the throat of the extruder may comprise microparticles which expand under the extremes of temperature and pressure to which such material is subjected during the extrusion process. An example of how to make and use such materials is provided in U.S. Pat. No. 6,890,965, hereby incorporated by reference herein.

In certain embodiments the extrudate may comprise a tri-layered or other multilayered composite product. Examples of three layered composite extruded products are known in the art, see for example, U.S. Pat. No. 6,827,995, which is hereby incorporated by reference herein.

The Extrusion Process

The steps involved in an extrusion process are well-known in the art, and the present invention need not introduce the need for significant alterations in such processes. Extruders may be single screw extruders or twin screw extruders. For co-extrusion of, for example, two different layers one such process may have a pair of feed chambers to mix and feed dry polymer materials into one of a pair of screw extruders. The screw extruders in turn feed the material which will comprise the first and second layers into an extrusion die or feedblock under predetermined temperature and pressure conditions. The relative location of each of the twin screw outputs and the design of the extrusion die influences the shape and composition of the extrudate, however the formation of a composite product containing a first and second layer is relatively straightforward.

Subsequent steps may include one or more of the following steps: embossing, preforming, calibration, water bath, roller and cutting the extrudate into appropriately sized planks, boards and the like, depending on their ultimate function.

In a preferred embodiment the pelleted or powdered mix comprising the transparent or translucent capstock and any additives (first dry mix) are mixed and fed into one of the two screw extruders. Optionally, the first dry mix may also comprise a conventional color concentrate in an amount between about 15% to about 0.001%, depending largely on the effect desired and the nature of the color concentrate. It will be understood that this range specifically discloses and includes any and all concentrations and ranges thereof falling between 15% and 0.001%, by weight. Preferably the color concentrate is also transparent or translucent. However, the color concentrate may in certain cases be opaque, in which case sufficiently little of the color concentrate is used to permit the final extrudate to have a capstock which is transparent or translucent. One or more filler may optionally be added to the first dry mix so long as it is not present in an amount causing the extruded first layer to become opaque. If wood flour is added to the first dry mix, it is present in an amount less than about 1% by weight. In one preferred embodiment, wood flour is not added to the capstock dry mix. The filler may comprise a plurality of decorative elements. In one embodiment the decorative elements may comprise color accent pellets. The color accent pellets may be added in an amount of between about 0.1% to about 10%, by weight. It will be understood that this range specifically discloses and includes any and all concentrations and ranges thereof falling between 0.1% and 10%, by weight. In another embodiment the first dry mix does not contain color accent pellets.

A second dry mix containing the base material is fed into the other extrusion screw. The base polymer may comprise a thermoplastic polymer, and preferably a filler. In the second dry mix, the polymer may comprise acrylonitrile/styrene/acrylic polymeric materials, acrylonitrile/butadiene/styrene polymeric materials, PVC polymeric materials, acrylic polymeric materials, acrylonitrile/ethylene/propylene/styrene polymeric materials, polycarbonate polymeric materials, polyolefins (such as polypropylene polymeric materials, polystyrene polymeric materials, and/or polyethylene polymeric materials), polyacetyl materials, fluorocarbon polymeric materials, nylons, phenoxy polymeric materials, polyethers, polycarbonates, polyphenylene oxides, polysulfones, polyimides, thermoplastic urethane elastomers, combinations thereof or mixtures or alloys thereof. If a filler is also included in the second dry mix, the filler may comprise wood (for example, without limitation, wood fiber, wood flour or sawdust), other organic fiber (such as, without limitation, coconut fiber, husks, nutshells, hemp, straw and the like), glass fiber (including random fibers, chopped fiber, glass mat or any other glass fiber-containing composition), mica, other inorganic fibers, metal shavings, talc and the like, and combinations thereof. If wood, the filler may be derived from a hardwood, a softwood, or a mixture of the two. If a filler is used, it is added in an amount between about 1% and about 65% by weight, depending in part on the nature of the filler. It will be understood that this range specifically discloses and includes any and all concentrations and ranges thereof falling between 1% and 65% by weight. Additionally or alternatively, the second dry mix may optionally comprise a filler comprising a decorative element such as a color accent pellet. The color accent pellets are added in an amount of between about 1% and about 10%, by weight. In one embodiment the second dry mix comprises a plurality of color accent pellet. It will be understood that this range specifically discloses and includes any and all concentrations and ranges thereof falling between 1% and 10%, by weight. In another embodiment the second dry mix does not comprise one or more color accent pellet.

The second dry mix may also contain a color concentrate. The color concentrate, if present, may be added in an amount of between about 1% and about 10%, by weight. The color concentrate used in the second dry mix may be transparent, translucent or opaque. Preferably the color concentrate used in the second dry mix is opaque.

The second dry mix may also contain an encapsulated foaming component comprises a polymer component and a blowing agent, wherein the polymer component encapsulates the blowing agent. This is described in, e.g., U.S. Pat. No. 6,827,995, incorporated by reference herein.

The output from the two extruder screws is fed into a die under predetermined conditions of temperature and pressure. Under these conditions the movement of the molten polymer through the die causes a bonding of the two layers and the “streaking” of the color accent pellets.

Preferred subsequent steps may also include calibration, followed by feeding the extrudate into vacuum cooling tanks, followed by an embossing step, a roller puller and a cutoff saw. However, one of skill in the art will recognize that alterations to this preferred process may be made without departing from the spirit of the invention.

Preferably, the composites of the present invention are in the form of a member having a length defined along a longitudinal axis of the member. The first layer is extruded as a thin coating (typically between about 0.005 inches to about 0.01 inches thick) over at least one surface of the base polymer. In one embodiment the first layer substantially completely circumscribes the second layer along substantially the entire length of the member. The second or additional layers may be solid or hollow (e.g., foamed). The member may have any suitable axial cross-section, such as circular, rectangular, oval, an irregularly shaped cross-section and the like. In one useful embodiment, the member has a substantially rectangular, for example, an elongated rectangular or square, axial cross-section, that is perpendicular to the length or longitudinal axis of the member.

### EXAMPLE 1

### Test Run

A test run was performed using a 2 ½ inch core extruder having a 24:1 length to diameter (L/D) ratio, and a 2 inch cap extruder having a 20:1 L/D ratio. The cap mix contained 30%, by weight, clear acrylic with about 2% brown color accent pellets having a melting point of between 325° F. to 400° F. homogeneously present in an amount of between 0.1% and 10% by weight. The core mix contained 70% woodfilled ABS, 25% wood flour, and 2% brown color accent pellets.

The cap extruder output was fed into the core extruder at the gate, located upstream of the die, in a fashion permitting the core to become encapsulated in the capstock before the extrudate is shaped by the die. A die was used that would shape the extrudate to form 3″ wide spa board materials.

Temperature parameters were as follows; the indicated locations are set forth in order from the extruder input (Zones 1), to the output (Die 6):

| | |
|---|---|
| Core extruder | Cap extruder |
| (15 rpm) | (20 rpm) |

| | Temperature | | Temperature |
|---|---|---|---|
| Location | (° F.) | Location | (° F.) |
| Zone 1 | 340 | Zone 1 | 270 |
| Zone 2 | 340 | Zone 2 | 280 |
| Zone 3 | 345 | Zone 3 | 290 |
| Zone 4 | 350 | Zone 4 | 290 |
| GATE | 330 | Adaptor | 290 |
| Die | 345 | | |
| Die | 345 | | |
| Die | 345 | | |
| Die | 345 | | |
| Die | 345 | | |
| Die | 340 | | |

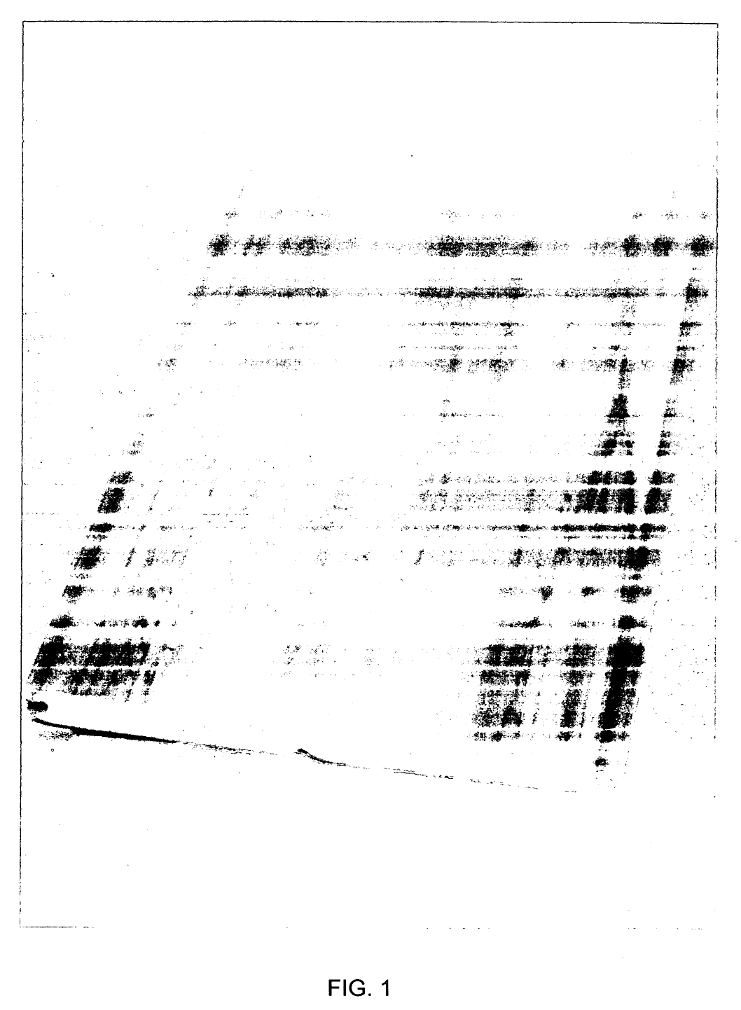

The resulting extrudate was cooled and cut as described previously. The spa board possesses a simulated wood grain pattern caused by streaks formed by the partially melted color accent pellets. The clear acrylic capstock permits these streaks the stand out and provides a depth and wood-like authenticity not seen using an opaque capstock. A spa board produced essentially as described is shown in FIG. 1, displaying clearly visible streaks both in the capstock and in the core layer underneath and thereby producing an extremely authentic tan wood-like surface. The tan color is produced by the wood flour in the underlying core layer, visible through the clear acrylic.

### EXAMPLE 2

### Second Test Run

Another test run was performed as described above with the following modification. A brown transparent acrylic color concentrate was added to the capstock dry mix at a concentration of 5% by weight. Again, color accent pellets were added to both capstock and core dry mixes in the proportions indicated above.

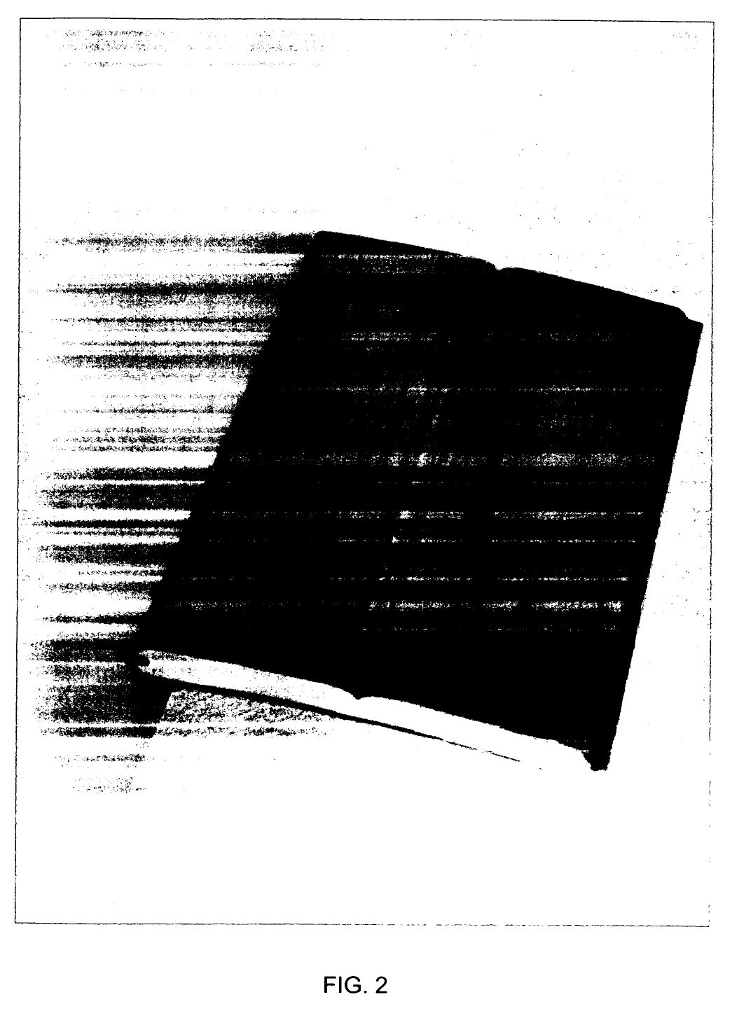

A spa board produced essentially as described in this Example 2 is shown in FIG. 2. As in Example 1, the board displays clearly visible streaks both in the capstock and in the core layer underneath. Additionally, the brown color concentrate creates an amber colored surface having the appearance of varnished fine teak. Despite the colored capstock, the streaks created by the color accent pellets in the capstock and core layers are clearly visible due to the transparency of the capstock layer.

### EXAMPLE 3

### Test Run using 5% Wood Flour in the Capstock

A third test run is performed essentially as described in Example 1, with the following modification. 5% wood flour is added to the capstock dry mix prior to extrusion.

The resulting spa board is tan in color and the streaks formed from the color accent pellets are visible on the surface of the capstock layer. However the wood fluor makes the capstock opaque, resulting in masking of the core layer underneath. The resulting streaks are not clearly defined, and the board has the appearance of rough-cut lumber having a surface layer of sawdust. Moreover, the surface streaks caused by the melting color accent pellets do not form clearly differentiated “fan-like” features resembling similar features in fine wood.

The invention has been described with regard to exemplary and preferred embodiments that illustrate rather than limit the invention. The present invention is defined solely by the claims that follow this description.

What is claimed is:

1. A composite thermoplastic composition comprising:
a) a first layer comprising a first polymeric material which contains a first polymer; and
b) a second layer, in contact with the first layer and comprising a second polymeric material, wherein said first polymeric material is sufficiently transparent or translucent to permit visualization of one or more decorative features present in said first and/or second polymeric layer.

2. The composition of claim 1 wherein said first polymeric material comprises a polymer selected from the group consisting of: ASA, acrylic, polystyrene, thermoplastic polyurethane, unplasticized polyvinyl chloride (RPVC), acrylonitrile/butadiene/styrene (ABS), polyethylene terephthalate (PET), polycarbonate, styrene/acrylonitrile (SAN), styrene-butadiene-copolymers (K-resins®), polyolefins, and alloys and mixtures comprising said polymer.

3. The composition of claim 2 wherein said polymer comprises a transparent or translucent acrylic.

4. The composition of claim 1 wherein said first polymeric material further comprises a color concentrate.

5. The composition of claim 4 wherein said color concentrate is transparent or translucent.

6. The composition of claim 4 wherein said color concentrate is opaque before it is added to said first polymeric material.

7. The composition of claim 1 wherein said composition is made by extrusion.

8. The composition of claim 1 wherein said composition is made by polymerization.

9. The composition of claim 7 wherein said first polymeric material further comprises one or more decorative feature caused by differentially melting of one or more discrete colored thermoplastic polymer particles located at least partly beneath the surface of, and at least partly visible through, said first polymeric layer.

10. The composition of claim 1 wherein at least of said first or second polymeric layer further comprises a filler selected from wood fiber, wood flour, sawdust, nut shells, coconut fiber, other cellulosic fibers, glass fiber, talc and metal shavings.

11. The method of claim 10 wherein said filler comprises wood flour at a concentration no greater than about 1% by weight.

12. The composition of claim 9 wherein at least one of said first or second polymeric layer further comprises a filler selected from wood fiber, wood flour, sawdust, nut shells, coconut fiber, other cellulosic fibers, glass fiber, talc and metal shavings.

13. The composition of claim 12 wherein said filler comprises wood flour at a concentration no greater than about 1% by weight.

14. The composition of claim 1 wherein said second layer comprises a polymeric material selected from the group consisting of acrylonitrile/styrene/acrylic polymeric materials, acrylonitrile/butadiene/styrene polymeric materials, PVC polymeric materials, acrylic polymeric materials, acrylonitrile/ethylene/propylene/styrene polymeric materials, polycarbonate polymeric materials, polyacetyl materials, fluorocarbon polymeric materials, nylons, phenoxy polymeric materials, polyolefins, polyethers, polycarbonates, polyphenylene oxides, polysulfones, polyimides, thermoplastic urethane elastomers, combinations thereof, mixtures thereof, and alloys thereof.

15. The composition of claim 1 wherein said second polymeric material further comprises one or more decorative feature caused by differentially melting of one or more color accent pellets at least partly visible through said first polymeric layer.

16. The composition of claim 1 wherein said composition visually resembles wood.

17. The composition of claim 9 wherein said composition visually resembles wood.

18. The composition of claim 15 wherein said composition visually resembles wood.

19. The composition of claim 1 that comprises a third layer comprising a third polymeric material.

20. The composition of claim 19 wherein at least one of said layers comprises a foamed polymeric material.

21. A method of making an extruded wood-containing composite product comprising:
coextruding
a) a first layer comprising a first transparent or translucent polymeric material which contains a first polymer; and
b) a second layer, in contact with the first layer and comprising a second polymeric material, wherein said first polymeric material is sufficiently transparent or to permit visualization of one or more decorative features in said first and/or second polymeric layer.

22. The method of claim 21 wherein said first layer is less than about 0.25 inches in thickness.

23. The method of claim 22 wherein said first layer is less than about 0.1 inches in thickness.

24. The method of claim 21 wherein a filler selected from wood fiber, wood flour, sawdust, nut shells, coconut fiber, other cellulosic fibers, glass fiber, talc and metal shavings is added to said first or second layer.

25. The method of claim 21 wherein said first layer comprises a decorative feature, provided that said decorative feature is not present in an amount sufficient to prevent said second layer from being at least partly visible through said first layer.

26. The method of claim 25 wherein said decorative feature comprises between 0% and about 10% wood flour by weight.

27. The method of claim 25 wherein said decorative feature comprises a color additive having a higher melting temperature than at least one other component in said layer.

28. The method of claim 21 wherein said second layer comprises a decorative feature.

29. The method of claim 28 wherein said decorative feature comprises a color additive having a higher melting temperature than at least one other component in said layer.

30. The method of claim 21 wherein said first polymer is selected from the group consisting of ASA, acrylic, polyolefin, thermoplastic polyurethane, unplasticized polyvinyl chloride (RPVC), acrylonitrile/butadiene/styrene (ABS), polyethylene terephthalate (PET), polycarbonate, styrene/acrylonitrile (SAN), and styrene-butadiene-copolymers (K-resins®).

31. The method of claim 21 wherein said second layer comprises a second polymer selected from the group consisting of ASA, acrylic, polyolefin, thermoplastic polyurethane, unplasticized polyvinyl chloride (RPVC), acrylonitrile/butadiene/styrene (ABS), polyethylene terephthalate (PET), polycarbonate, styrene/acrylonitrile (SAN), and styrene-butadiene-copolymers (K-resins®).

32. The method of claim 31 wherein a filler selected from wood fiber, wood flour, sawdust, nut shells, coconut fiber, other cellulosic fibers, glass fiber, and metal shavings is added to said second polymer before being included in an extruder.

33. The method of claim 21 wherein said composite product is extruded in the form of a plank or board.

34. The method of claim 33 wherein said extruded composite product is cooled, then embossed.

35. The method of claim 21 wherein said extruded composite product comprises decorative features in both said first and second layer.
